(19) United States
(12) Patent Application Publication
(10) Pub. No.: US 2009/0248808 A1
(43) Pub. Date: Oct. 1, 2009

(54) Methods and Apparatus for Transmitting Attachments Using a Mail Send/Receive Program

(76) Inventors: Kouichi Izumi, Yokohama city (JP); Kohsuke Okamoto, Sagamihara-shi (JP)

Correspondence Address: Ryan, Mason & Lewis, LLP, 90 Forest Avenue, Locust Valley, NY, 11560, US

(21) Appl. No.: 12/057,521

(22) Filed: Mar. 28, 2008

(51) Int. Cl. G06F 15/16

(52) U.S. Cl. 709/206

(57) ABSTRACT

Techniques for transmitting attachment data through a network are provided. Attachment data from an attachment sender is obtained. A copy of the attachment data is stored at a storage location as stored attachment data. The obtained attachment data is replaced with program code. The program code is transmitted to at least one recipient designated by the attachment sender. The stored attachment data is accessible by the at least one recipient under control of the program code.

### FIELD OF THE INVENTION

The present invention relates to data management of computer-based communications and, more particularly, to techniques for handling electronic data.

### BACKGROUND OF THE INVENTION

Electronic mail (e-mail) is not only a common vehicle for sending messages, but for sending data in the form of attachments. Attachment data can be anything from word processing files to multimedia files. No one can dispute that e-mail and attachments have changed the way we communicate as a society. Today, an e-mailer can send an attachment to anybody in the world with a click of a button. However, as simple as e-mailing data has become for the common person, e-mail and attachment data management has become a system fraught with inefficiency, waste, and lack of security.

As more e-mailers send larger attachments in greater quantity, e-mail servers suffer a dramatic decrease in processing speed. Under conventional techniques, e-mail providers combat this problem by increasing storage space to support the overflow of attachment data. This solution is ineffective and only leads to more waste. In order to effectively increase processing speeds, e-mail providers must change the way attachment data is processed. Currently, e-mail providers utilize a push-type model of e-mail, where attachments are forwarded together with an e-mail. This technique wastes storage space and processing time because the model encourages redundancy. For example, if a sender e-mails a large attachment file to multiple recipients, each recipient will receive an individual copy of the same large attachment, even if a recipient has no interest in the attachment. Redundancy is also found when senders revise attachment data. Using conventional techniques, in order to disseminate revised attachment data, a sender must retransmit the revised attachment data in its entirety to all recipients. As a result, previous and irrelevant versions of an attachment unnecessarily consume e-mail storage space.

With regard to security, currently, there are no convenient solutions which allow senders to prevent the unauthorized viewing and dissemination of attachment data. After an attachment is e-mailed, a sender can not limit who can view the attachment. Furthermore, after receiving an attachment, a recipient can easily disseminate the attachment data to others without restriction. Conventional solutions to these problems include encrypting/password protecting attachments before e-mailing. However, this solution requires the use of additional encryption/decryption packages which are time consuming and inconveniencing for both parties because each party must own a copy of the encryption/decryption package. Furthermore, even if an encryption package is utilized, conventional techniques do not allow senders to monitor access to an attachment. For instance, after an attachment is e-mailed, a sender will never know the access history of an attachment (e.g., who, what, when, where, and how). Conventional techniques have utilized link replacement, where web links are sent to e-mail recipients instead of attachment data. The e-mail recipients use the web links to login into web accounts where they can download attachment data. Senders can monitor any access to attachment data at the linked website. However, this solution is impractical for the average, unsophisticated attachment sender.

Therefore, there is a need for techniques for transmitting attachments that: (1) considerably reduce the processing time for transmitting attachment data; (2) allow senders to control access to e-mailed attachments; (3) allow senders to monitor the access history of an attachment; and (4) prevent unnecessary retransmission of attachment data after revisions.

### SUMMARY OF THE INVENTION

Principles of the present invention provide techniques that overcome the above-mentioned drawbacks associated with existing methods by providing techniques that address the above needs, as well as other needs. More particularly, principles of the invention give attachment senders the ability to manage and monitor their attachment data. Further, the proposed techniques decrease attachment data processing/transmission time and reduce data storage usage at an e-mail server.

In accordance with one aspect of the present invention, a method for transmitting attachment data through a network is provided. Attachment data from an attachment sender is obtained. A copy of the attachment data is stored at a storage location as stored attachment data. The obtained attachment data is replaced with program code. The program code is transmitted to at least one recipient designated by the attachment sender. The stored attachment data is accessible by the at least one recipient under control of the program code.

The stored attachment data may be accessible to the attachment sender to: (i) view the stored attachment data; (ii) append the stored attachment data; (iii) save the stored attachment data; and/or (iv) delete the stored attachment data. Further, the stored attachment data may be archived, compressed, encoded, and/or password protected. In addition, the program code may be operative to extract the stored attachment data, expand the stored attachment data, decode the stored attachment data, and/or unlock the stored attachment data. The program code may also be operative to prevent the at least one recipient from disseminating the stored attachment data.

In an alternative embodiment, the storage location may be operative to transmit the stored attachment data to the program code as a plurality of data segments. Further, the program code may be operative to recombine the plurality of data segments, recreating the stored attachment data.

In an additional embodiment of the invention, a setting file may be created. The setting file may comprise attachment data information, an access control list, and/or an access log. The access control list may comprise a level of access for the at least one recipient to: (i) view the stored attachment data; (ii) append the stored attachment data; (iii) save the stored attachment data; and/or (iv) delete the stored attachment data. The setting file may be stored at the storage location. Further, access to the stored attachment data may be in accordance with the setting file.

In a second aspect of the present invention, an article of manufacture for transmitting attachment data through a network comprises a computer readable storage medium identified by one or more programs, which when executed by a computer implement the above steps.

In accordance with a third aspect of the present invention, an apparatus for transmitting attachment data through a network comprises: a memory; and at least one processor coupled to the memory and operative to: (i) obtain attachment data from an attachment sender; (ii) store a copy of the attachment data at a storage location as stored attachment data; (iii) replace the obtained attachment data with program code; and (iv) transmit the program code to at least one recipient designated by the attachment sender. The stored attachment data is accessible by the at least one recipient under control of the program code.

In a fourth aspect of the present invention, a system for transmitting attachment data through a network is provided. The system comprises: a device; at least one server connected to the device via a communications network; and at least one processor operatively coupled to the device, the processor being operative to: (i) obtain attachment data from an attachment sender; (ii) store a copy of the attachment data at a storage location as stored attachment data; (iii) replace the obtained attachment data with program code; and (iv) transmit the program code to at least one recipient designated by the attachment sender. The stored attachment data is accessible by the at least one recipient under control of the program code.

These and other objects, features, and advantages of the present invention will become apparent from the following detailed description of illustrative embodiments thereof, which is to be read in connection with the accompanying drawings.

### BRIEF DESCRIPTION OF THE DRAWINGS

FIG. 1 is a flow diagram illustrating a methodology for transmitting attachment data through a network, according to an embodiment of the present invention.

FIG. 2 is an exemplary system diagram illustrating an interaction between an attachment sender, an e-mail client, an e-mail server, and a recipient, according to an embodiment of the present invention.

FIG. 3 is a flow diagram illustrating an interaction between a sending user, a mail client for the sending user, an extension manager, a file server, a mail server, an add-in program of the mail server, a mail send/receive program, a receiving user, and a mail client for the receiving user as applied to a given example, according to one embodiment of the present invention.

FIG. 4 is a diagram illustrating an illustrative hardware implementation of a computing system in accordance with which one or more components/methodologies of the present invention may be implemented, according to an embodiment of the present invention.

### DETAILED DESCRIPTION OF PREFERRED EMBODIMENTS

The present invention will be described in conjunction with exemplary methods for transmitting attachment data through a network. It should be understood, however, that the invention is not limited to the particular embodiments described herein. The principles of this invention are generally applicable to any technique of transmitting data, and modifications to the illustrative embodiments will become apparent to those skilled in the art given the teachings described herein.

The term “attachment” as used herein is intended to be construed broadly so as to encompass, by way of example and without limitation, any type of data (e.g., music, video, pictures, word processing, etc.) attached to a message.

The term “program code” as used herein is intended to be construed broadly so as to encompass, by way of example and without limitation, any organized list of instructions that, when executed, causes a computer-based device to behave in a predetermined manner.

The term “server” as used herein is intended to be construed broadly so as to encompass, by way of example and without limitation, a computer-based device capable of managing network resources and data.

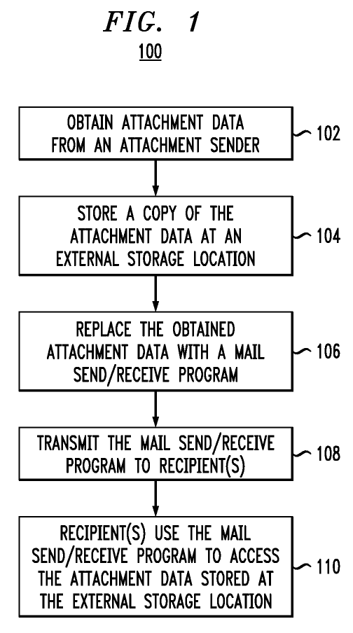

Referring initially to FIG. 1, a flow diagram illustrates a methodology 100 for transmitting attachment data through a network, according to an embodiment of the present invention. In an exemplary embodiment, methodology 100 may be carried out by an e-mail client or an e-mail server, or a combination thereof. Methodology 100 begins at step 102 where attachment data from a sender is obtained. In an illustrative embodiment, the attachment sender may be a person or an automated system. Further, the attachment data may comprise, but is not limited to, word processing files, compressed files, database files, music files, and image files. A sender may be directing the attachment data to one or more recipients via a networked communications system (e.g., the internet).

At step 104, a copy of the attachment data is stored at an external storage location (e.g., an e-mail server). In an illustrative embodiment, the external storage is designated storage space maintained by an e-mail server for the sender. The external storage may also be a file database independent of the e-mail server and maintained by a third-party. In an exemplary embodiment, the attachment sender may view, append, save, and/or delete the stored attachment data located at the external storage location or e-mail server as illustrated in this example.

At step 106, the obtained attachment data addressed to one or more recipients is replaced with program code, which may be any program used to control access to the stored attachment data. In an illustrative embodiment, the program code is a mail send/receive program. The mail send/receive program may be a compact downloader used to retrieve the attachment data stored at the external storage location. However, it is to be appreciated that although the illustrative embodiments described herein refer to a mail send/receive program, it is to be understood that the invention is not limited to this one embodiment and any program code which controls access to stored data may be implemented. At step 108, the mail send/receive program (e.g., program code) is transmitted in place of the attachment data, to the one or more recipients designated by the attachment sender.

At step 110, the one or more recipients use the mail send/receive program to access the attachment data stored at the e-mail server. In an exemplary embodiment, the mail send/receive program sends a download request to the e-mail server when activated. The request may identify the location of the stored attachment data to be downloaded.

In an additional embodiment, the e-mail server may authenticate the recipient via username and password or other identifier (e.g., internet protocol (IP) address) prior to giving access to the attachment. The authentication process may be in accordance with a setting file which is setup by an attachment sender prior to e-mailing a recipient. The setting file may include an access control list which comprises a level of access for one or more recipients. Level of access may define the ability of a recipient to view, append, save, and/or delete a stored attachment file. For example, one recipient may have the ability to view, save, and append stored attachment data, while another recipient may only have the ability to view the stored attachment data.

In an exemplary embodiment, the setting file may also include attachment data information and an access log. Attachment data information may include the location of where the attachment data is stored and/or data type and size. Attachment data information may assist in locating attachment data on the e-mail server. An access log may include information on the date, time, action, and identity of an accessing entity. The access log is used to monitor access to attachment data. The setting file may be conveniently stored together with the stored attachment data at the e-mail server.

When a request from a mail send/receive program is accepted by the e-mail server, the server may transmit the attachment data to the mail send/receive program as multiple data segments. By utilizing multiple data segments, the transmission time for attachment data may be reduced because the multiple data segments are smaller in size and can be transmitted through multiple internet routes. Multiple data segments also reduce recovery time for a failed transmission. If a transmission fails for any reason, it is unnecessary to retransmit the entire attachment file. Rather, only those data segments which have failed are resent. The overall result is reduced internet traffic.

In an illustrative embodiment, the mail send/receive program receives and recombines the multiple data segments to recreate the stored attachment data. In an additional embodiment, the mail send/receive program may delete the reconstructed attachment data to prevent a recipient from disseminating the attachment. For example, if a recipient only has the ability to view an attachment file, the downloaded attachment file is deleted after it is viewed by the recipient.

In an exemplary embodiment, the attachment data is preprocessed before it is stored at the e-mail server. The attachment data may be archived, compressed, encoded, and password protected. Archiving may be beneficial if multiple attachment files are being sent and the attachment sender would rather compile the files into one file. Compression may decrease a attachment size for easier and faster transmission. Encoding the attachment prevents unauthorized users from accessing the attachment. Encoding prior to storage at the e-mail server adds extra security because even users with access to the e-mail server cannot view the attachment data without an appropriate decoder. Password protection may also provide additional security to attachment data. In the alternative, the e-mail server, or external storage location, may archive, compress, encode, and password protect the attachment data.

In order to successfully download and present the attachment data to a recipient, the mail send/receive program may be operative to extract archived attachment data, expand compressed attachment data, decode encoded attachment data, and unlock, via password, password protected attachment data.

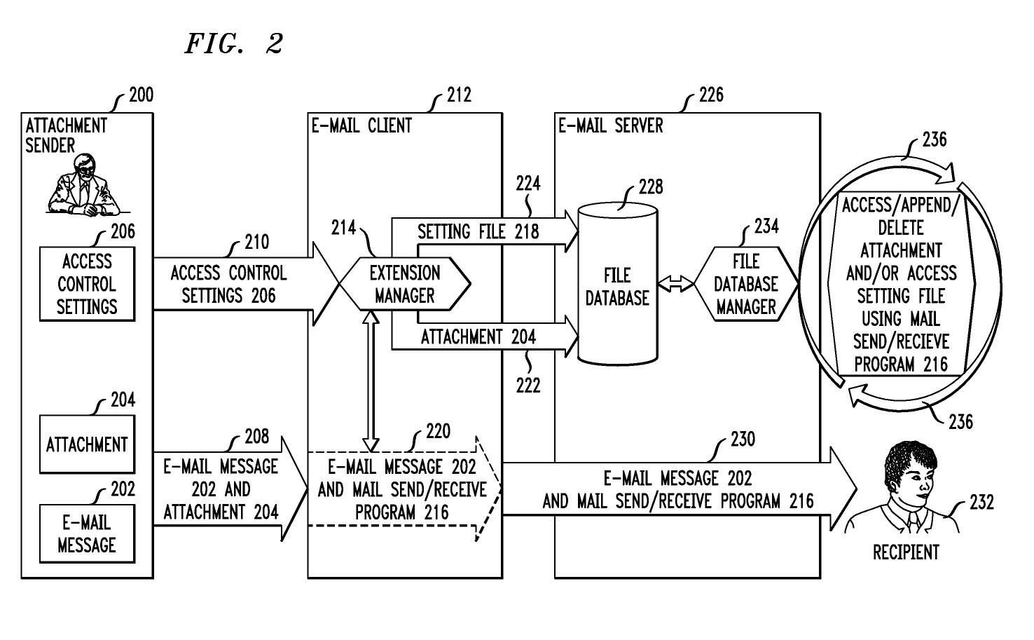

FIG. 2 is an exemplary system diagram illustrating an interaction between an attachment sender 200, an e-mail client 212, an e-mail server 226, and a recipient 232, according to an embodiment of the present invention. The system begins with attachment sender 200 who may be a user or automated system. In this exemplary embodiment, the attachment sender 200 formulates an e-mail message 202 and selects an attachment 204 directed to one or more recipients. Further, the attachment sender 200 may consider limiting access to the attachment only to those one or more recipients. To do this, the attachment sender 200 considers access control settings 206. The access control settings 206 may comprise the level of access for each recipient. Level of access may define an ability to either view, append, save, and/or delete the attachment data.

E-mail client 212 carries out steps 102 through 108 of methodology 100 of FIG. 1. At flow 208, using an e-mail client 212, the attachment sender 200 inputs the e-mail message 202 and attaches the attachment 204 to the e-mail message 202. The e-mail client 212 may be any e-mail composing application (e.g., IBM Lotus Notes™). At flow 210, the attachment sender 200 may also input his or her preferred access control settings 206. In an illustrative embodiment, the e-mail client 212 comprises an extension manager 214, which is a plug-in module for the e-mail client. The extension manager may: (1) process access control settings 206 and create a setting file 218, (2) replace an e-mail attachment 204 with a send/receive program 216, and (3) store the attachment 204 and the setting file 218 at an external database, or file database 228 (flows 222 and 224, respectively). The file database 228 may comprise a file system, or other mechanism for storing and organizing files. In an additional embodiment, the setting file 218 comprises attachment data information (e.g., size, type, and location of the attachment data), an access control list (e.g., a list of entities authorized to view, save, delete, and/or append the attachment data), and/or an access log e.g., access history of an attachment). Further, the setting file 218 is stored together with the attachment 204 at the file database 228 located, in this example, at e-mail server 226.

In an exemplary embodiment, the extension manager 214 obtains the e-mail attachment 204 and saves a copy of the attachment 204 at file database 228 (flow 222). The attachment sender 200 may access the file database 228 to view, append, save, and/or delete the stored attachment data 204. One advantage of storing a distributed attachment 204 at a single master location is to minimize storage space usage. For example, if the attachment sender 200 decides to revise the attachment 204, the attachment sender 200 can update the existing version of the attachment at the file database 228 instead of redistributing the revised attachment.

In an additional alternative embodiment, prior to storing the attachment 204 at the file database 228, the extension manager 214 may archive, compress, encode, and/or password protect the attachment data 204 for security purposes.

In addition to storing the attachment 204, the extension manager 214 may also create a setting file 218 from the inputted access control settings 206. The setting file 218 may also be stored at the file database 228 (flow 224) together with the attachment data 204.

After a copy of the attachment 204 is stored at file database 228, the extension manager 214 replaces the e-mail attachment 204 with a send/receive program 216. The mail send/receive program 216 is later used by a recipient 232 to access the attachment data 204 stored at file database 228. The e-mail client 212 then sends the e-mail message 202 and mail send/receive program 216 to the e-mail server 226 (e.g., IBM Lotus Domino™). At flow 230, the e-mail server 226 forwards the e-mail message 202 and mail send/receive program 216 to a recipient 232 designated by the attachment sender 200.

Recipient 232 carries out step 110 of the methodology illustrated at FIG. 1. At flow 236, the recipient 232 uses the mail send/receive program 216 e-mailed together with the e-mail message 202 to access the attachment data 204 stored at file database 228. It is to be appreciated that the recipient 232 may not want to access the stored attachment data and therefore, may not activate the mail send/receive program 216. This process differs from conventional techniques which utilize a push method of attachment delivery (e.g., every recipient receives a full copy of an attachment). Under a pull method of attachment delivery, internet traffic caused by constant downloading and uploading of attachment data is reduced because attachment data is accessed only on a need basis.

In an illustrative embodiment, the recipient 232, using the mail send/receive program 216, interacts with a file database manager 234 (e.g., an add-in program at the mail server) to gain access to the file database 228. The file database manager 234, using the access control settings 206 stored in the setting file 218, may authenticate the recipient 232 before giving access to the stored attachment data. Furthermore, the file database manager 234 locates and fetches the attachment data using attachment information (e.g., filename, type, size, location) contained in the setting file 218.

In an exemplary embodiment, if the recipient 232 is authorized to access (e.g., view, save, append, and/or delete) the stored attachment data, the mail send/receive program 216 downloads the attachment data. In a preferred embodiment, the stored attachment data is transmitted to the mail send/receive program 216 as multiple data segments. The use of multiple data segments allow for faster processing and transmission of the attachment data because smaller packets of data are sent via various transmission routes. Another way in which processing time is reduced is during transmission failures. Using conventional techniques, an e-mail server must restart an attachment download if the download fails. By utilizing multiple data segments, an attachment does not have to be retransmitted from scratch, rather, only failed data segments need to be resent. Multiple data segments also speed up the process of revising attachment data. If an attachment sender 200 revises attachment data 204, only those segments which have been revised are stored at file database 228. Further, if a recipient 232 requests the revised attachment data, the recipient may only need to download the revised data segments. This is more efficient than repeatedly uploading and downloading entire files of revised attachment data.

If the downloaded attachment data is archived, compressed, encoded, and/or password protected, the mail send/receive program 216 may be operative to extract, expand, decode, and/or unlock, respectively, the attachment data. In addition to downloading, the mail send/receive program 216 may also provide the recipient 232 access to the setting file 218 stored at file database 228. This may depend on the level of access of the recipient 232. If the recipient 232 has access rights to alter the setting file 218, the recipient 232 may change the access settings (e.g., who can or can not access the attachment) of the setting file 218 via the mail send/receive program 216. The revised setting file is then uploaded into the file database 228. The file database manager 234 may then use the revised setting file to determine if a future user has access to the attachment data stored at the file database 228.

When handling the downloaded attachment data, the recipient 232 may view, append, save, and/or delete the stored attachment data depending on the level of access of the recipient. The right to view means that the attachment data can only be accessed in a read-only format. In an illustrative embodiment, the mail send/receive program will delete the downloaded attachment data or stored attachment data after it is viewed to prevent unauthorized dissemination of the attachment data. The right to append means that the recipient 232 can make revisions to the attachment data and overwrite the attachment data stored at the file database 228. The right to save means that the recipient 232 may save the attachment data to his or her personal computer which may result in distribution to others. The right to delete means that the recipient 232 may delete the attachment data stored at the file database 228. No matter what the action, the action, time of the action, location of the action, and entity making the action is recorded under access history in the setting file 218. This information is saved at the file database 228 and may be used to monitor access to the stored attachment.

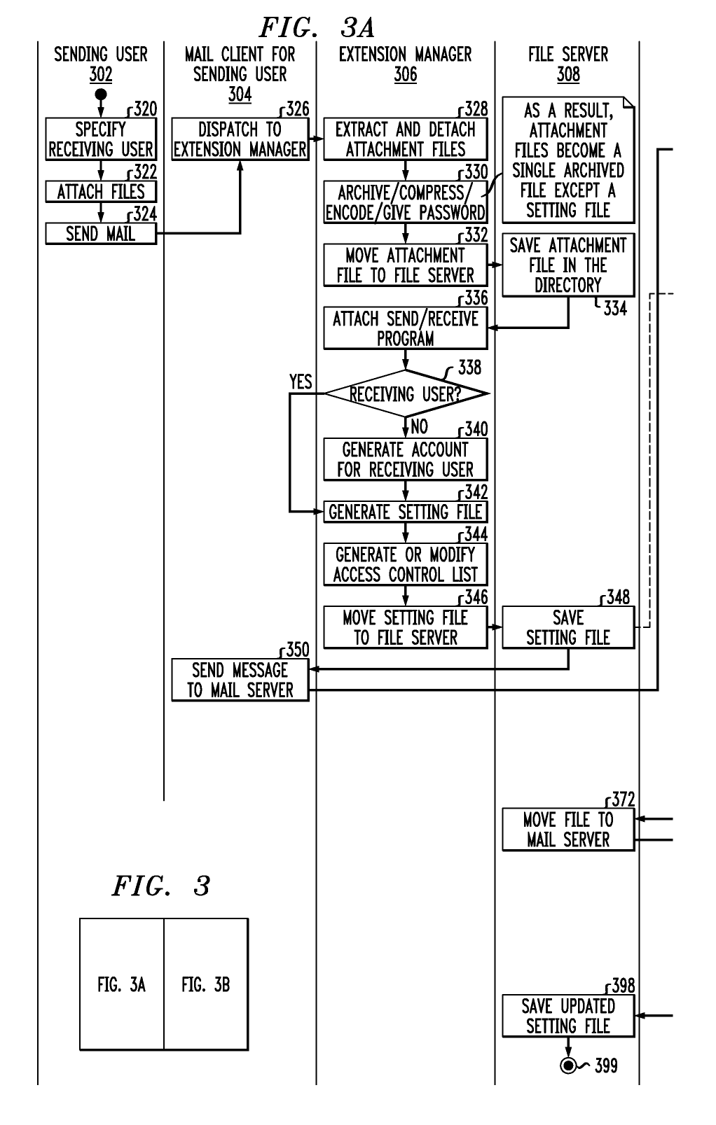

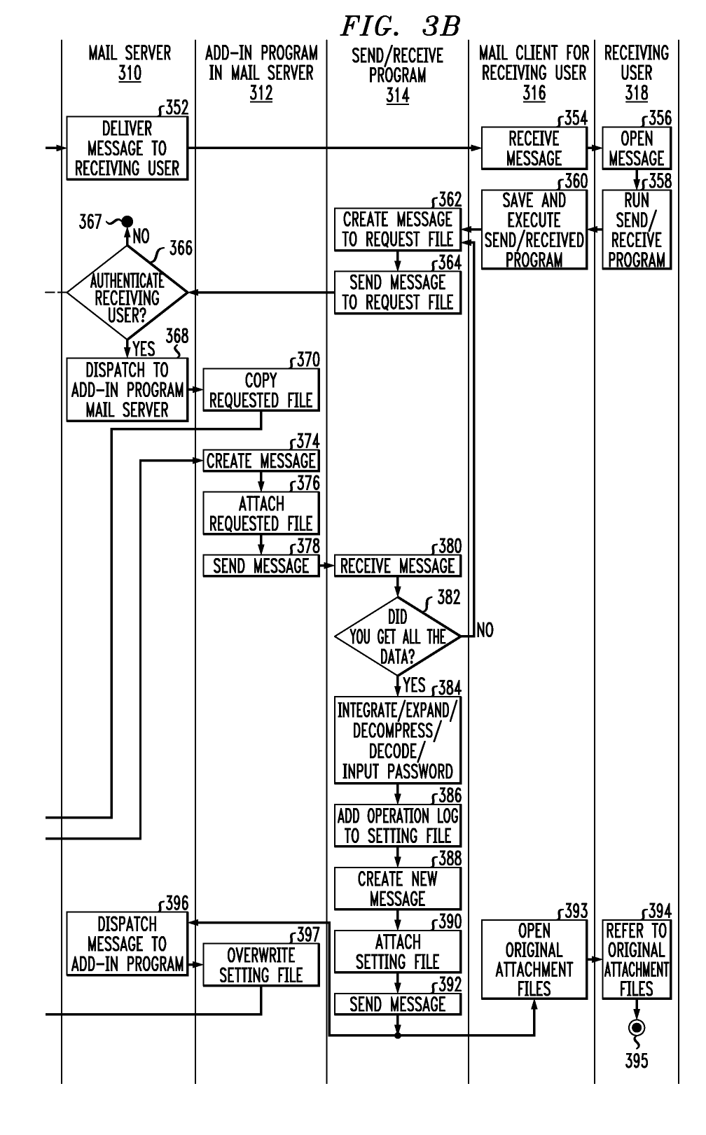

Referring now to FIG. 3, a flow diagram illustrates an interaction between a sending user 302, a mail client for the sending user 304, an extension manager 306, a file server 308, a mail server 310, an add-in program of the mail server 312, a mail send/receive program 314, a receiving user 318, and a mail client for the receiving user 316 as applied to a given example, according to one embodiment of the present invention. By way of example and without loss of generality, FIG. 3 illustrates one embodiment of the present invention. At step 320, using a mail client 304, a sending user 302 (e.g., attachment sender) specifies one or more receiving users by one or more e-mail addresses. At step 322, the sending user 302 attaches one or more files (e.g., attachments) to an e-mail for transmission to the one or more recipients. At step 324, the mail is sent by the user 302. At step 326, the mail client for the sending user 304 dispatches the mail to the extension manager 306, which may be a plug-in application of the mail client 304.

At step 328, the extension manager 306 detaches the one or more attachments 322 from the sent mail. At step 330, the extension manager 306 may archive, compress, encode, and/or password protect the attached files 322. In this example, the extension manager 306 compresses multiple attachments and creates one archived attachment file. At step 332, the extension manager moves the attachment file to a file server 308. The file server 308 may be storage space on a mail server 310 designated to the sending user 302 or the file server may be an external server maintained by a third-party. The file server 308 saves the attachment file in a directory for storage at step 334.

At step 336, the extension manager 306 attaches a mail send/receive program 314 in place of the detached attachment file. Using the extension manager 306, the sending user 302 may define a level of access for a receiving user. At step 338, it is determined if a receiving user is defined. If not, the sending user 302 may generate an account for the receiving user at step 340. After an account is setup for the receiving user, the sending user 302 may then generate a setting file at step 342. At step 344, the sending user 302 can generate an access control list or modify an existing access control list by inputting access rights. Access rights may include various levels of access for different entities. For example, the sending user (e.g., “From:”) may have rights to attach the attachment to other e-mails (e.g., disseminate), revise the attachment, save the attachment, and/or delete the attachment. A recipient (e.g., “To:”), may have rights to attach the attachment to other e-mails, and/or save the attachment file. A carbon-copied recipient (e.g., “Cc:”) may have rights only to save the attachment file. A blind carbon-copied recipient (e.g., “Bcc:”) may have no access rights to the attachment file.

At step 346, the extension manager 306 moves the setting file to the file server 308. At step 348, the file server 308 saves the setting file, preferably with the saved attachment file. At step 350, the mail client of the sending user 304 then sends the mail with the attached send/receive program 314 to the mail server 310. The mail server 310 delivers the mail to a mail client of a receiving user 316 at step 352. The mail client of the receiving user 316 receives the message at step 354 and presents it to the receiving user 318.

At step 356, the receiving user 318 opens the mail message which contains the mail send/receive program 314 as an attachment. At step 358, the receiving user 318 runs the send/receive program 314. At step 360, the mail client of the receiving user 316 saves and executes the send/receive program 314. The send receive/program 314 creates a message to request the attachment file stored at the file server 308 at step 362. At step 364, the message is sent to the mail server 310.

At step 366, using the setting file, the mail server 310 authenticates the receiving user 318 before granting access to the attachment file. If the receiving user 318 is not authorized to access the attachment file, the process ends at 367. If the receiving user 318 is authorized, at step 368, the request from the mail send/receive program 314 is dispatched to an add-in program in the mail server 312.

The add-in program 312 is responsible for handling requests from send/receive programs. At step 370, the add-in program copies the requested attachment file by moving the attachment file from the file server 308 to the mail server 310 (step 372). The add-in program 312 then creates a reply message at step 374 and attaches the requested attachment file at step 376. At step 378, the message with the attachment is then transmitted to the send/receive program 314. This process may be accomplished using multiple data segments as illustrated in the description of FIG. 2.

At step 380, the send/receive program 314 receives the message with the attachment data. At step 382, the send/receive program 314 determines if all the attachment data was received. If not, the send/receive program 314 creates a new message to request the attachment data (step 362). If the attachment data was sent as multiple data segments, a request for only those missing segments will be made. If the attachment data is complete, the send/receive program 314 may extract, expand, decode, and/or unlock the attachment (step 384). At step 386, the event of accessing the attachment is recorded to an operation log (e.g., access log information) in the setting file. At step 388, a new message is created. In this example, at step 390, the setting file stored at the file server 308 is attached to the new message. At step 392, the message is sent to the receiving user 318 via the mail client 316. At step 393, the mail client of the receiving user 316 opens the original attachment files and presents them to the user. At step 394, the receiving user 318 views the original attachment files and the process ends at 395.

Concurrently, the message, which is sent to the mail client of the receiving user 316 from the send/receive program 314 at step 392, is also sent to the mail server 310. The mail server 310 dispatches the message to the add-in program 312 at step 396. The add-in program overwrites the setting file (step 397) stored at the file server 308. At step 398, the setting file with updated access log information is saved and the process ends at 399.

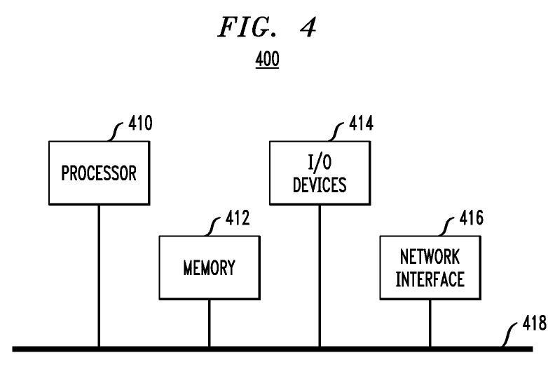

Referring now to FIG. 4, step diagram 400 illustrates an exemplary hardware implementation of a computing system in accordance with which one or more components/methodologies of the invention (e.g., components/methodologies described in the context of FIGS. 1-6) may be implemented, according to an embodiment of the present invention.

As shown, the techniques for transmitting attachment data through a network may be implemented in accordance with a processor 410, a memory 412, I/O devices 414, and a network interface 416, coupled via a computer bus 418 or alternate connection arrangement.

It is to be appreciated that the term “processor” as used herein is intended to include any processing device, such as, for example, one that includes a CPU (central processing unit) and/or other processing circuitry. It is also to be understood that the term “processor” may refer to more than one processing device and that various elements associated with a processing device may be shared by other processing devices.

The term “memory” as used herein is intended to include memory associated with a processor or CPU, such as, for example, RAM, ROM, a fixed memory device (e.g., hard drive), a removable memory device (e.g., diskette), flash memory, etc.

In addition, the phrase “input/output devices” or “I/O devices” as used herein is intended to include, for example, one or more input devices (e.g., keyboard, mouse, scanner, etc.) for entering data to the processing unit, and/or one or more output devices (e.g., speaker, display, printer, etc.) for presenting results associated with the processing unit.

Still further, the phrase “network interface” as used herein is intended to include, for example, one or more transceivers to permit the computer system to communicate with another computer system via an appropriate communications protocol.

Software components including instructions or code for performing the methodologies described herein may be stored in one or more of the associated memory devices (e.g., ROM, fixed or removable memory) and, when ready to be utilized, loaded in part or in whole (e.g., into RAM) and executed by a CPU.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

1. A method for transmitting attachment data through a network, the method comprising the steps of:
obtaining attachment data from an attachment sender;
storing a copy of the attachment data at a storage location as stored attachment data;
replacing the obtained attachment data with program code; and
transmitting the program code to at least one recipient designated by the attachment sender, wherein the stored attachment data is accessible by the at least one recipient under control of the program code.

2. The method of claim 1, wherein the stored attachment data is accessible to the attachment sender to at least one of view the stored attachment data, append the stored attachment data, save the stored attachment data, and delete the stored attachment data.

3. The method of claim 1, wherein the stored attachment data is at least one of archived, compressed, encoded, and password protected.

4. The method of claim 3, wherein the program code is operative to at least one of extract the stored attachment data, expand the stored attachment data, decode the stored attachment data, and unlock the stored attachment data.

5. The method of claim 1, wherein the program code is operative to prevent the at least one recipient from disseminating the stored attachment data.

6. The method of claim 1, wherein the storage location is operative to transmit the stored attachment data to the program code as a plurality of data segments, the program code being operative to recombine the plurality of data segments, recreating the stored attachment data.

7. The method of claim 1, further comprising the step of creating a setting file, wherein the setting file comprises at least one of an attachment data information, an access control list, and an access log, further wherein the setting file is stored at the storage location.

8. The method of claim 7, wherein access to the stored attachment data is in accordance with the setting file.

9. The method of claim 7, wherein the access control list comprises a level of access for the at least one recipient to at least one of view the stored attachment data, append the stored attachment data, save the stored attachment data, and delete the stored attachment data.

10. An article of manufacture for transmitting attachment data through a network, the article comprising a computer readable storage medium identified by one or more programs, which when executed by a computer implement the steps of claim 1.

11. An apparatus for transmitting attachment data through a network, the apparatus comprising:
a memory; and
at least one processor coupled to the memory and operative to: (i) obtain attachment data from an attachment sender; (ii) store a copy of the attachment data at a storage location as stored attachment data; (iii) replace the obtained attachment data with program code; and (iv) transmit the program code to at least one recipient designated by the attachment sender, wherein the stored attachment data is accessible by the at least one recipient under control of the program code.

12. The apparatus of claim 11, wherein the stored attachment data is accessible to the attachment sender to at least one of view the stored attachment data, append the stored attachment data, save the stored attachment data, and delete the stored attachment data.

13. The apparatus of claim 11, wherein the stored attachment data is at least one of archived, compressed, encoded, and password protected.

14. The apparatus of claim 13, wherein the program code is operative to at least one of extract the stored attachment data, expand the stored attachment data, decode the stored attachment data, and unlock the stored attachment data.

15. The apparatus of claim 11, wherein the program code is operative to prevent the at least one recipient from disseminating the stored attachment data.

16. The apparatus of claim 11, wherein the storage location is operative to transmit the stored attachment data to the program code as a plurality of data segments, the program code being operative to recombine the plurality of data segments, recreating the stored attachment data.

17. The apparatus of claim 11, wherein the processor is further operative to create a setting file, wherein the setting file comprises at least one of an attachment data information, an access control list, and an access log, further wherein the setting file is stored at the storage location.

18. The apparatus of claim 17, wherein access to the stored attachment data is in accordance with the setting file.

19. The apparatus of claim 17, wherein the access control list comprises a level of access for the at least one recipient to at least one of view the stored attachment data, append the stored attachment data, save the stored attachment data, and delete the stored attachment data.

20. A system for transmitting attachment data through a network, the system comprising:
a device;
at least one server connected to the device via a communications network; and
at least one processor operatively coupled to the device, the processor being operative to: (i) obtain attachment data from an attachment sender; (ii) store a copy of the attachment data at a storage location as stored attachment data; (iii) replace the obtained attachment data with program code; and (iv) transmit the program code to at least one recipient designated by the attachment sender, wherein the stored attachment data is accessible by the at least one recipient under control of the program code.
